(19) United States
(12) Patent Application Publication
(10) Pub. No.: US 2021/0375149 A1
(43) Pub. Date: Dec. 2, 2021

(54) SYSTEM AND METHOD FOR PROFICIENCY ASSESSMENT AND REMEDIAL PRACTICE

(71) Applicant: Lumas Information Services, LLC, Piscataway, NJ (US)

(72) Inventor: Mukunda Krishnaswamy, Princeton, NJ (US)

(73) Assignee: Lumas Information Services, LLC

(21) Appl. No.: 16/890,026

(22) Filed: Jun. 2, 2020

(51) Int. Cl. G09B 7/00; G06Q 30/02; G06Q 50/20; G06Q 10/06; G06Q 10/10; G06K 7/14

(52) U.S. Cl. CPC G09B 7/00; G06Q 30/0205; G06Q 50/205; G06K 7/1417; G06Q 10/10; G06K 7/1413; G06Q 10/06393

(57) ABSTRACT

A system and a method for proficiency assessment and remedial practice is disclosed. The system includes a performance information receiving subsystem to receive performance information of a learner from at least one source, a learner assessment subsystem to determine a current proficiency level of the learner, a performance comparison subsystem to determine difference between the current proficiency level and first predetermined threshold limit. A remedial subsystem to recommend a set of remedial practices to the learner. A deep remedial subsystem including a test administration module to conduct a practice test. A proficiency assessment module to determine difference in the current proficiency level of the learner and a second predetermined threshold limit, identifies a learning requirement of the learner recurrently using a coherence map and recommends a set of deep remedial practices to the learner recurrently. The system also allows for enhanced interaction for the learner via an interactive digital assistant.

### BACKGROUND

Embodiments of the present disclosure relate to a machine-controlled learning process for educating a learner, and more specifically, to a system and a method for proficiency assessment and administration of remedial practice to address proficiency gaps.

In today's world, education has become a lifelong process of learning ranging from learners in schools to adult learners seeking personal and professional development. The increasing demand has led to the rise of a number of learning mechanisms and tools to facilitate effective learning. Typically, the educational system is based on teaching new concepts to learners and testing the mastery of the learners before advancing the learners to a next stage of learning. Such a system is a function of the validity of the tests conducted and an accurate assessment of the results. Such assessment reports usually provide reliable information about a learner's proficiency relative to a group of learners and do not provide information on any specific pattern of mastery in a particular skill, his/her strengths and weaknesses, and additional related information underlying a learner's response. Such additional information may help learners and educators better analyze the test grades and the kinds of learning which might help to improve their standards mastery.

With the advent of internet and fast-paced changes in technology, there are a number of software applications and online learning tools available to improve the traditional process of learning. However, such tools fall short of offering an effective personalized approach to enable a learner to gain knowledge in a skill or domain of interest and advance to a higher level at the desired pace. In one example, advancements by the learner through interaction with a first learning application provides little guidance for recommendation to a second, advanced tutorial for the learner. Furthermore, in another example, the learning tools lack systematic tracking and monitoring of the learner's progress and growth.

Hence, there is a need for an improved learning system and method for effective proficiency assessment and remedial practice in order to address the aforementioned issues.

### BRIEF DESCRIPTION

In accordance with an embodiment of the present disclosure, a system for proficiency assessment and remedial practice is disclosed. The system includes a performance information receiving subsystem to receive performance information of a learner from at least one source. The system also includes a learner assessment subsystem to determine a current proficiency level of the learner upon identification of a plurality of performance parameters from the performance information received by the performance information receiving subsystem. The system also includes a performance comparison subsystem to determine a difference between the current proficiency level and a first predetermined threshold limit of the proficiency level corresponding to a current grade level standard used in a predefined geographic location. The system also includes a remedial subsystem to recommend a set of remedial practices to the learner in an event that the current proficiency level is below the first predetermined threshold limit. The system also includes a deep remedial subsystem, wherein the deep remedial subsystem includes a test administration module to conduct a practice test based on an evaluation of performance of the set of remedial practices recommended to the learner. The deep remedial subsystem also includes a proficiency assessment module to determine the difference in the current proficiency level of the learner and a second predetermined threshold limit of the proficiency level corresponding to the current grade level standard based on the practice test attempted by the learner. The proficiency assessment module also identifies a learning requirement of the learner recurrently using a coherence map when the current proficiency level of the learner is below the second predetermined threshold limit of the proficiency level. The proficiency assessment module also recommends a set of deep remedial practices to the learner recurrently based on an identification of the learning requirement.

In accordance with another embodiment, a system for proficiency assessment and remedial practice with an interactive digital assistant is disclosed. The system includes a performance information receiving subsystem to receive performance information of a learner from at least one source. The system also includes a learner assessment subsystem to determine a current proficiency level of the learner upon identification of a plurality of performance parameters from the performance information received by the performance information receiving subsystem. The system also includes a performance comparison subsystem to determine a difference between the current proficiency level and a first predetermined threshold limit of the proficiency level corresponding to a current grade level standard used in a predefined geographic location. The system also includes a remedial subsystem to recommend a set of remedial practices to the learner in an event that the current proficiency level is below the first predetermined threshold limit. The system also includes a deep remedial subsystem, wherein the deep remedial subsystem includes a test administration module to conduct a practice test based on an evaluation of performance of the set of remedial practices recommended to the learner. The deep remedial subsystem also includes a proficiency assessment module to determine the difference in the current proficiency level of the learner and a second predetermined threshold limit of the proficiency level corresponding to the current grade level standard based on the practice test attempted by the learner. The proficiency assessment module also identifies a learning requirement of the learner recurrently using a coherence map when the current proficiency level of the learner is below the second predetermined threshold limit of the proficiency level. The proficiency assessment module also recommends a set of deep remedial practices to the learner recurrently based on identification of the learning requirement. The system also includes an interactive digital assistant to receive an input query associated with a learning process from the learner in one or more formats. The interactive digital assistant also interprets the input query to commence a personalized conversation for each of the learner based on at least one of the current proficiency level of the learner, an achievement of the learner corresponding to the current grade level standard, a type of past interaction of each of the learner, feedback of an educator or a combination thereof. The interactive digital assistant also analyzes each response obtained from each of the learners to provide a corresponding personalized recommendation upon commencement of the personalized conversation. The interactive digital assistant also provides a set of guided practices to the learner in accessing one or more educational resources based on an analysis of each response and the personalized recommendation.

In accordance with yet another embodiment of the present disclosure, a method for proficiency assessment and remedial practice is disclosed. The method includes receiving performance information of a learner from at least one source. The method also includes determining a current proficiency level of the learner upon identification of a plurality of performance parameters from the performance information received by the performance information receiving subsystem. The method also includes determining a difference between the current proficiency level and a first predetermined threshold limit of the proficiency level corresponding to a current grade level standard used in a predefined geographic location. The method also includes recommending a set of remedial practices to the learner in an event that the current proficiency level is below the first predetermined threshold limit. The method also includes conducting a practice test based on an evaluation of performance of the set of remedial practices recommended to the learner. The method also includes determining the difference in the current proficiency level of the learner and a second predetermined threshold limit of the proficiency level corresponding to the current grade level standard based on the practice test attempted by the learner. The method also includes identifying a learning requirement of the learner recurrently using a coherence map when the current proficiency level of the learner is below the second predetermined threshold limit of the proficiency level. The method also includes recommending a set of deep remedial practices to the learner recurrently based on an identification of the learning requirement.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram of a system for proficiency assessment and remedial practice in accordance with an embodiment of the present disclosure;

FIG. 2 illustrates a schematic representation of an exemplary embodiment of a system for proficiency assessment and remedial practice of FIG. 1 in accordance with an embodiment of a present disclosure;

FIG. 3 is a block diagram of a computer or a server in accordance with an embodiment of the present disclosure; and

FIG. 4 is a flow chart representing the steps involved in a method for proficiency assessment and remedial practice of FIG. 1 in accordance with the embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system and a method for proficiency assessment and remedial practice. The system includes a performance information receiving subsystem to receive performance information of a learner from at least one source. The system also includes a learner assessment subsystem to determine a current proficiency level of the learner upon identification of a plurality of performance parameters from the performance information received by the performance information receiving subsystem. The system also includes a performance comparison subsystem to determine a difference between the current proficiency level and a first predetermined threshold limit of the proficiency level corresponding to a current grade level standard used in a predefined geographic location. The system also includes a remedial subsystem to recommend a set of remedial practices to the learner in an event that the current proficiency level is below the first predetermined threshold limit. The system also includes a deep remedial subsystem, wherein the deep remedial subsystem includes a test administration module to conduct a practice test based on an evaluation of performance of the set of remedial practices recommended to the learner. The deep remedial subsystem also includes a proficiency assessment module to determine the difference in the current proficiency level of the learner and a second predetermined threshold limit of the proficiency level corresponding to the current grade level standard based on the practice test attempted by the learner. The proficiency assessment module also identifies a learning requirement of the learner recurrently using a coherence map when the current proficiency level of the learner is below the second predetermined threshold limit of the proficiency level. The proficiency assessment module also recommends a set of deep remedial practices to the learner recurrently based on an identification of the learning requirement.

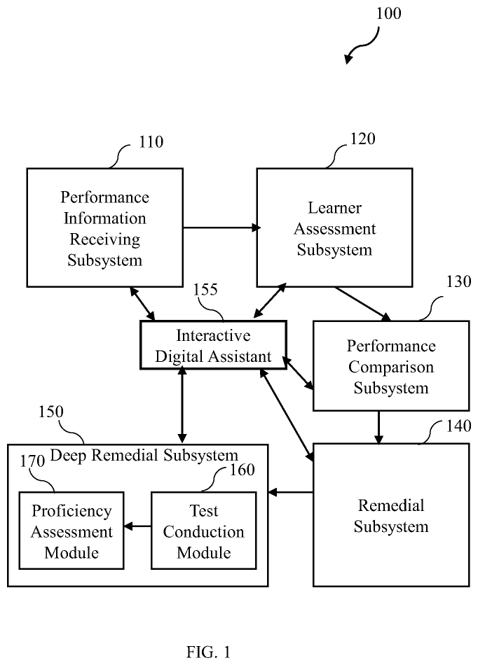

FIG. 1 is a block diagram of a system 100 for proficiency assessment and remedial practice in accordance with an embodiment of the present disclosure. The system 100 includes a performance information receiving subsystem 110 to receive performance information of a learner from at least one source. As used herein, the term ‘learner’ is defined as a person who wants to acquire knowledge or skill of a particular subject matter of a particular state assessment standard. In one embodiment, the learner may include a student or an individual of a predefined age group. Similarly, the term ‘performance information’ is defined as details of performance of the learner by utilizing one or more resources to meet one or more objectives in the learning process. In another embodiment, the performance information of the learner may be received from the at least one source, wherein the at least one source includes an assessment, an assessment report card or a combination thereof. In one embodiment, the assessment may include an online assessment. In another embodiment, the assessment may include an offline assessment.

The performance information receiving subsystem 110 receives performance information of the learner, upon registration of the learner, through scanning of an assessment report card of the learner, scanning a unique code of a printed book for taking the assessment or using an access code of an online account for the assessment. The performance information receiving subsystem 110 supports import of the performance information of the learner which could be in multiple file formats such as .csv, .xls, and the like. In some embodiment, the unique code may include a barcode, a quick response (QR) code, an alphanumeric code and, the like. In a specific embodiment, the learner, a parent, or an educator may scan the assessment report card to obtain the performance information associated with the learner. In one embodiment, the performance information receiving subsystem 110 also receives learner's demographic information which may include at least one of learner's name, learner's age, learner's geographical location, learner's educational background details or, a combination thereof.

The system 100 also includes a learner assessment subsystem 120 to determine a current proficiency level of the learner upon identification of a plurality of performance parameters from the performance information received by the performance information receiving subsystem 110. In one embodiment, the multiple performance parameters may include at least one of grades secured by the learner, details of a selection of one or more subjects by the learner for assessment, number of questions attempted by the learner, time taken by the learner to attempt each question, time taken by the learner to solve a difficult question, time taken by the learner to complete an assessment or a combination thereof

The system 100 also includes a performance comparison subsystem 130 to determine a difference between the current proficiency level and a first predetermined threshold limit of the proficiency level corresponding to a current grade level standard of used in a predefined geographic location. As used herein, the term ‘current grade level standard’ is defined as a learning objective defined by the curriculum used in the predefined geographical location for a particular grade. Similarly, the term ‘first predetermined threshold limit’ is defined the proficiency level which is set as a benchmark corresponding to a current industrial standard of the curriculum used in the predefined geographical location. In one embodiment, the predefined geographical location may include but not limited to, a location of a city, state, country and the like.

The system 100 also includes a remedial subsystem 140 to recommend a set of remedial practices to the learner in an event that the current proficiency level is below the first predetermined threshold limit. In one embodiment, the set of remedial practices may include at least one of one or more practice questions, one or more assignments of one or more subjects, one or more video lectures, one or more guidance tips or a combination thereof. In a specific embodiment, the first predetermined threshold limit of the proficiency level of the learner may be stored in a proficiency level database. In such embodiment, the proficiency level database may be hosted in a local server. In another embodiment, the proficiency level database may be hosted in a remote server. In one embodiment, the set of remedial practices may be sent to the learner through multiple notifications which may include at least one of a push notification such as a text message, a multimedia message, an electronic mail, a pop-up notification or a combination thereof. In a particular embodiment, the remedial subsystem also recommends directly an advanced set of practices to the learner corresponding to a higher-grade level standard relative to the current grade level standard when the current proficiency level of the learner is above the first predetermined-threshold limit. In such embodiment, the learner may skip practicing of the remedial set of practices and may directly practice the advanced set of practices corresponding to a next grade—level standard for obtaining advanced knowledge.

The system 100 also includes a deep remedial subsystem 150, wherein the deep remedial subsystem 150 includes a test administration module 160. The test administration module 160 conducts a practice test based on an evaluation of performance of the set of remedial practices recommended to the learner. The practice test is conducted to check an improvement level in the performance of the learner upon practicing the set of remedial practices. The deep remedial subsystem 150 also includes a proficiency assessment module 170 to determine the difference in the current proficiency level of the learner and a second predetermined threshold limit of the proficiency level corresponding to the current grade level standard based on the practice test attempted by the learner. As used herein, the term ‘second predetermined threshold limit’ is defined as the benchmark for determining performance of the learner in the practice test corresponding to the current proficiency level after the set of remedial practices. In one embodiment, the difference in the current proficiency level of the learner and a second predetermined threshold limit may refer to an achievement or an improvement of the learner. In another embodiment, the difference in the current proficiency level of the learner and a second predetermined threshold limit may refer to failure or deterioration of performance of the learner.

The proficiency assessment module 170 also identifies a learning requirement of the learner recurrently using a coherence map when the current proficiency level of the learner is below the second predetermined threshold limit of the proficiency level. As used herein, the term ‘learning requirement’ is defined as foundational knowledge requirement corresponding to a lower grade level standard. In one embodiment, the coherence map may include a visual representation of a relationship between grade-level standards. In such an embodiment, the visual representation may include at least one of a chart, a graph, a matrix, a table, a diagram or a combination thereof. The coherence map provides information related to a previous level, a next level, and similar standards. The coherence map helps the educator and the learner to visually explore the grade-level standards. Also, the coherence map helps the learner to progress through the grade-level standard and the educator to develop one or more pacing charts and one or more lesson plans.

The proficiency assessment module 170 also recommends a set of deep remedial practices to the learner recurrently based on identification of the learning requirement. In one embodiment, the set of deep remedial practices may include at least one of one or more preliminary knowledge level questions, one or more comprehensive skills, one or more retests, one or more references for tutorials corresponding to a lower grade level standard relative to the current grade level standard or a combination thereof. In a specific embodiment, the proficiency assessment module 170 also identifies an advanced knowledge requirement recurrently using a coherence map when the current proficiency level of the learner is above the second predetermined threshold limit. In such embodiment, the proficiency assessment module 170 imparts a subsequent set of practices corresponding to a higher-grade level standard relative to the current grade level standard when the current proficiency level of the learner is above the second predetermined threshold limit. In such an embodiment, the subsequent set of practices may include at least one of one or more higher order aptitude questions, multiple advanced concepts, multiple advanced sub-concepts or a combination thereof.

The system 100 also includes an interactive digital assistant 155. The interactive digital assistant 155 involved in the learning process, receives an input query associated with the learning process from a learner in one or more formats. In one embodiment, the one or more formats may include a voice format. In another embodiment, the one or more formats may include a text format. In yet another embodiment, the one or more formats may include an image format. The interactive digital assistant 155 also understands or interprets the input query to commence a personalized conversation for each of the learner based on at least one of the current proficiency level of the learner, an achievement of the learner corresponding to the current grade level standard, a type of past interaction of each of the learner, feedback of an educator or a combination thereof. As used herein, the term ‘achievement of the learner’ is defined as successful completion of topics, syllabus or course by the learner in the predefined learning standard. Similarly, the term ‘type of past interaction’ is defined as an answer or a response which is provided by the learner corresponding to a particular question in the past. In one embodiment, the type of previous response may include at least one of an accurate response, a rapid response or a combination thereof. In an embodiment, the interactive digital assistant 155 interprets the input query using a natural language processing technique.

The interactive digital assistant 155 upon commencing the personalized conversation also analyzes each response obtained from each of the learners to provide a corresponding personalized recommendation for one or more subjects. In one embodiment, the personalized recommendation may include a recommendation for improvement of at least one specific subject of the curriculum. The interactive digital assistant 155 also provides higher visibility or priority to important messages which are assigned by the educator for each of the learners. The interactive digital assistant 155 also provides a set of guided practices like a tutor to each of the learners in accessing one or more education resources of the learning process based on an analysis of each response and the personalized recommendation. The set of guided practices helps the learner in accessing the one or more educational resources from one or more external or internal sources by ensuring quick access to right resources without wastage of time and effort. In yet another embodiment, the interactive digital assistant enables a ‘strict mode’ for the learner as recommended by the educator and facilitates the learner to focus on a correct set of learning resources and content thereby avoiding potential diversion of attention. As used herein, the term ‘strict mode’ refers to user experience in a student portal that allows the learner to interact with the student portal in a pre-defined restricted manner.

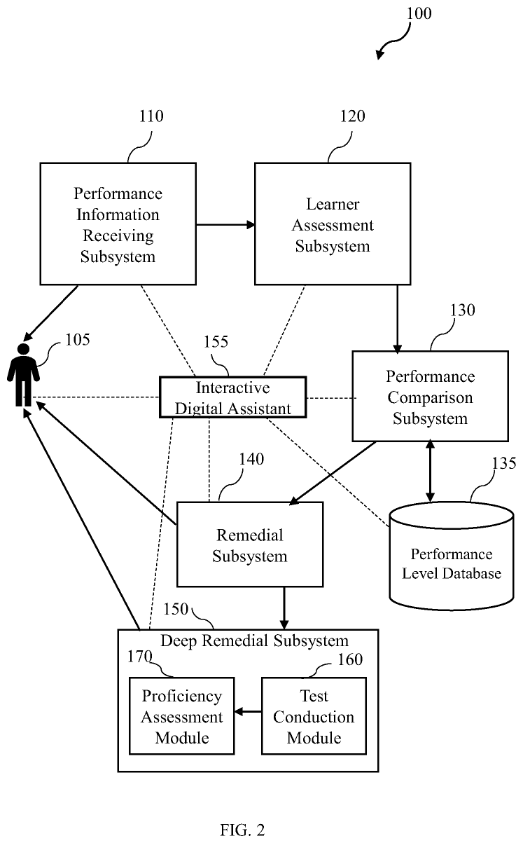

FIG. 2 illustrates a schematic representation of an exemplary embodiment of a system 100 for proficiency assessment and remedial practice of FIG. 1 in accordance with an embodiment of a present disclosure. The system 100 assesses a learner's learning progress by proficiency assessment of the learner ‘X’ 105. The system 100 overcomes manual intervention involved in the proficiency assessment of the learner ‘X’ 105 and thus provides an unbiased, consistent measurement of progress of the learner ‘X’ 105. For example, let us assume that the learner ‘X’ 105, himself wants to be aware of his current skill level. In such a scenario, the learner ‘X’ 105 needs to provide his performance information, so that the assessment of the current proficiency level learner ‘X’ 105 can be determined. Here, the learner ‘X’ 105 may provide the performance information either through scanning of an assessment report card or may appear in an online assessment of multiple subjects upon registration. Suppose the learner ‘X’ 105 does not want to appear for the assessment in the present time period, then in such a case, the learner ‘X’ 105 may scan the assessment report card for a last assessment. In such a condition, a performance information receiving subsystem 110 receives the performance information associated with the learner ‘X’ 105, by fetching scanned details of the assessment report card.

Once the performance information is received, the current proficiency level of the learner ‘X’ 105 corresponding to a current grade level standard used in a predefined geographical location is determined by a learner assessment subsystem 120. The learner assessment subsystem 120 identifies multiple performance parameters from the performance information. In an example used herein, the multiple performance parameters include at least one of grades secured by the learner 105, details of selection of one or more subjects by the learner ‘X’ 105 for the assessment, number of questions attempted by the learner ‘X’ 105, time taken by the learner 105 to attempt each question, time taken by the learner to complete difficult questions, time taken by the learner ‘X’ 105 to complete the assessment or a combination thereof.

Later, upon determination of the current proficiency level of the learner ‘X’ 105, a performance comparison subsystem 130 determines a difference between the current proficiency level and a first predetermined threshold limit of the proficiency level corresponding to the current grade level standard used in a predefined geographic location. For example, the predefined geographical location may include a state. The first predetermined threshold limit of the proficiency level is stored in a performance level database 135, wherein the performance level database 135 is hosted on a remote server such as a cloud server. Upon comparison of the current proficiency level of the learner, a set of remedial practices is recommended to the learner ‘X’ 105 by a remedial subsystem 140 in an event that the current proficiency level is below the first predetermined threshold limit through multiple notifications. For example, the set of remedial practices may include at least one of one or more practice questions, one or more assignments of one or more subjects, one or more video lectures, one or more guidance tips or a combination thereof. Also, the multiple notifications may include an email, a short message service (SMS) or a popup message.

Again, as the current proficiency level of the learner ‘X’ 105 is below the first predetermined threshold limit, in such a scenario, further training of the learner is required, and further training is made possible by providing deep remedial practices. A deep remedial subsystem 150 which includes a test administration module 160 conducts a practice test based on an evaluation of performance of the set of remedial practices recommended to the learner ‘X’ 105. In the example used herein, the practice test is conducted to check an improvement level in the performance of the learner upon practicing the set of remedial practices. Once, the practice test is completed, the deep remedial subsystem 150 also includes a proficiency assessment module 170 which determines the difference in the current proficiency level of the learner and a second predetermined threshold limit of the proficiency level corresponding to the current grade level standard based on the practice test attempted by the learner. Suppose if the current proficiency level of the learner ‘X’ 105 is still determined as below the second predetermined threshold limit, then it is observed that the learner 105 is not performing well even after several attempts of the training or teaching.

As a result, the proficiency assessment module 170 identifies a learning requirement of the learner ‘X’ 105 recurrently using a coherence map when the current proficiency level of the learner ‘X’ 105 is below the second predetermined threshold limit of the proficiency level. In the example used herein the learning requirement may include a foundational knowledge requirement of the learner. For example, the coherence map may include a visual representation of a relationship between grade—level standards. Here, the visual representation may include at least one of a chart, a graph, a matrix, a table, a diagram or a combination thereof. The coherence map is also used by the educator for the visual representation of learners' performance across multiple grade-level standards to gain insights into why a learner might be struggling in a particular grade level standard.

Again, the proficiency assessment module 170 based on identification of the foundational knowledge requirement recommends a set of deep remedial practices to the learner ‘X’ 105 recurrently based on identification of the learning requirement. For example, the set of deep remedial practices may include at least one of one or more preliminary knowledge level questions, one or more comprehensive skills, one or more retests, one or more references for tutorials corresponding to a lower grade level standard relative to the current grade level standard or a combination thereof.

Further, the system 100 includes an interactive digital assistant 155 which receives an input query associated with the learning process from the learner ‘X’ 105 in one or more formats. In an example used herein, the one or more formats may include a voice format. The interactive digital assistant 155 also understands or interprets the input query to commence a personalized conversation for each of the learner based on at least one of the current proficiency level of the learner, an achievement of the learner, a type of past interaction of each of the learner, feedback of the educator or a combination thereof. For example, the type of previous response may include at least one of an accurate response, a rapid response or a combination thereof. In a non-limiting example, the interactive digital assistant 155 interprets the input query using a natural language processing technique. Upon understanding the input query, the interactive digital assistant 155 determines a context and provides a reply corresponding to the input query for commencing the personalized conversation.

Further, the interactive digital assistant 155 upon commencing the personalized conversation also analyzes each response obtained from each of the learners to provide a corresponding personalized recommendation for one or more subjects. In one embodiment, the personalized recommendation may include a recommendation for improvement of at least one specific subject of the curriculum. The interactive digital assistant 155 also provides visibility or priority for important messages which are assigned by the educator for each of the learners. The interactive digital assistant 155 also provides a set of guided practices like the educator to each of the learners in accessing one or more education resources of the learning process based on an analysis of each response and the personalized recommendation. The set of guided practices helps each of the learners in accessing the one or more educational resources from one or more external or internal sources by ensuring quick access to right resources without wastage of time and effort. Moreover, the interactive digital assistant 155, further aids in recognizing the learner's current proficiency level by assessment of several factors and provides personalized recommendation to the learner ‘X’ 105 for mastering a skill for performance improvement. So, as a result, the learner ‘X’ 105 gets an overall idea about his proficiency level and moreover gets an idea about one or more skills which he/she needs to improve in order to progress in the learning process.

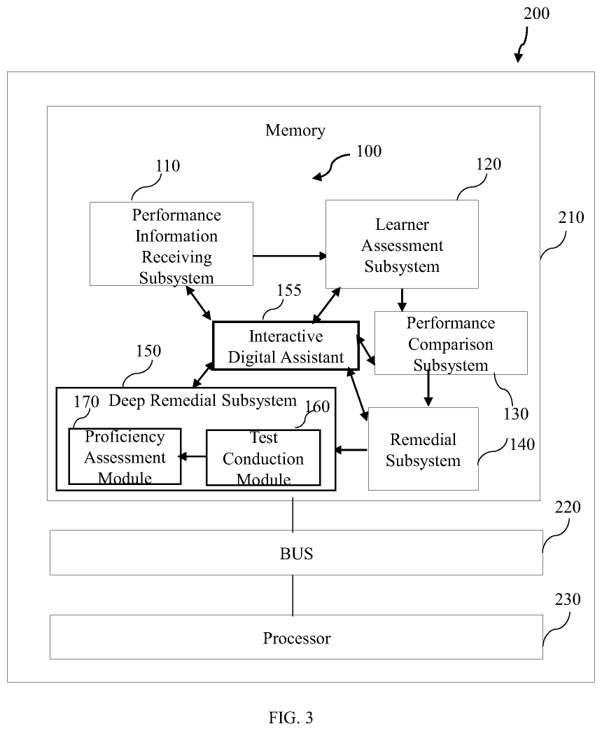

FIG. 3 is a block diagram of a computer or a server in accordance with an embodiment of the present disclosure. The server 200 includes processor(s) 230, and memory 210 operatively coupled to the bus 220. The processor(s) 230, as used herein, includes any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 210 includes several subsystems stored in the form of executable program which instructs the processor 230 to perform the method steps illustrated in FIG. 1. The memory 210 is substantially similar to a system 100 of FIG. 1. The memory 210 has the following subsystems: a performance information receiving subsystem 110, a learner assessment subsystem 120, a performance comparison subsystem 130, a remedial subsystem 140, a deep remedial subsystem 150 including a test administration module 160 and a proficiency assessment module 170.

The system 100 includes a performance information receiving subsystem 110 to receive performance information of a learner from at least one source. The system 100 also includes a learner assessment subsystem 120 to determine a current proficiency level of the learner upon identification of a plurality of performance parameters from the performance information received by the performance information receiving subsystem. The system 100 also includes a performance comparison subsystem 130 to determine a difference between the current proficiency level and a first predetermined threshold limit of the proficiency level corresponding to a current grade level standard used in a predefined geographic location. The system 100 also includes a remedial subsystem 140 to recommend a set of remedial practices to the learner in an event that the current proficiency level is below the first predetermined threshold limit. The system 100 also includes a deep remedial subsystem 150, wherein the deep remedial subsystem 150 includes a test administration module 160 to conduct a practice test based on an evaluation of performance of the set of remedial practices recommended to the learner. The deep remedial subsystem 150 also includes a proficiency assessment module 170 to determine the difference in the current proficiency level of the learner and a second predetermined threshold limit of the proficiency level corresponding to the current grade level standard based on the practice test attempted by the learner. The proficiency assessment module 170 also identifies a learning requirement of the learner recurrently using a coherence map when the current proficiency level of the learner is below the second predetermined threshold limit of the proficiency level. The proficiency assessment module 170 also recommends a set of deep remedial practices to the learner recurrently based on identification of the learning requirement.

The system 100 also includes an interactive digital assistant 155 which receives an input query associated with the learning process from a learner in one or more formats. The interactive digital assistant 155 also understands or interprets the input query to commence a personalized conversation with the learner based on at least one of the current proficiency level of the learner, an achievement of the learner corresponding to the current grade level standard, a type of past interaction of the learner, feedback of an educator or a combination thereof. The interactive digital assistant 155 also analyzes each response obtained from the learner to provide a corresponding personalized recommendation on one or more subjects. The interactive digital assistant 155 also provides higher visibility or priority to important messages which are assigned by the educator to the learner. The interactive digital assistant 155 also provides a set of guided practices to the learner in accessing one or more educational resources of the learning process based on an analysis of each response of the learner and provides personalized recommendation.

The bus 220 as used herein refers to the internal memory channels or computer network that is used to connect computer components and transfer data between them. The bus 220 includes a serial bus or a parallel bus, wherein the serial bus transmits data in a bit-serial format and the parallel bus transmits data across multiple wires. The bus 220 as used herein, may include but not limited to, a system bus, an internal bus, an external bus, an expansion bus, a frontside bus, a backside bus and the like.

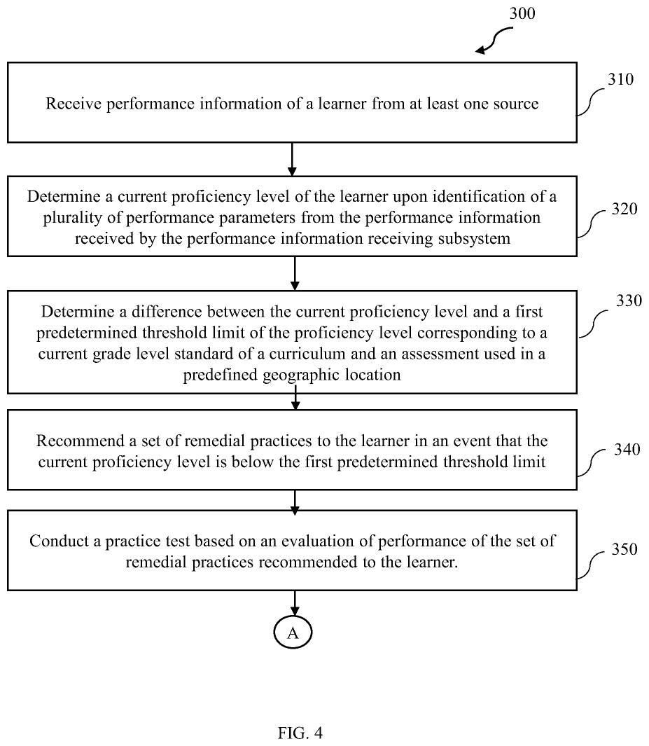

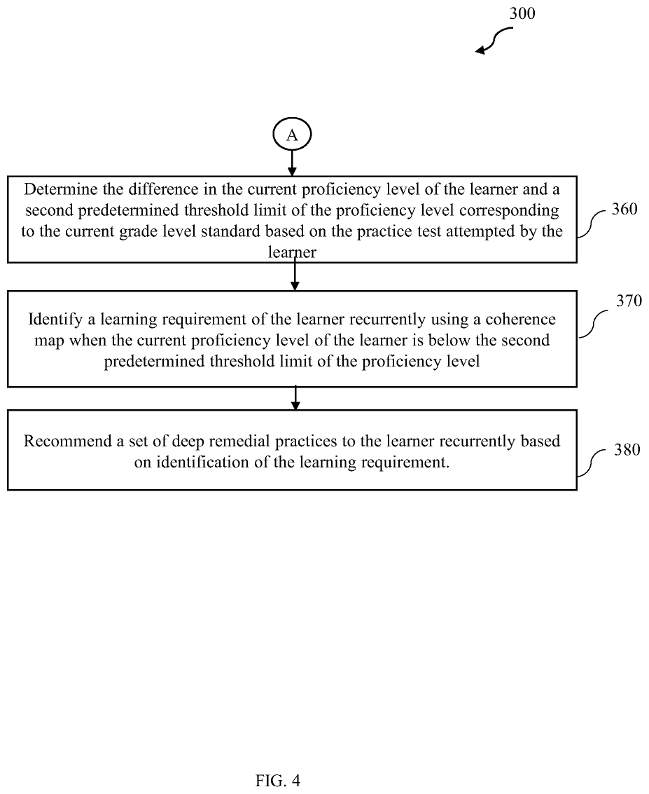

FIG. 4 is a flow chart representing the steps involved in a method 300 for proficiency assessment and remedial practice of FIG. 1 in accordance with the embodiment of the present disclosure. The method 300 includes receiving performance information of a learner from at least one source in step 310. In one embodiment, receiving the performance information of the learner may include receiving the performance information from the at least one source which may include an assessment, an assessment report card or a combination thereof. In such embodiment, receiving the performance information of the learner from the at least one source may include receiving the performance information by scanning of an assessment report card of the learner, a unique code of a printed book for the assessment or using an access code of an online account for the assessment.

The method 300 also includes determining a current proficiency level of the learner upon identification of a plurality of performance parameters from the performance information received by the performance information receiving subsystem in step 320. In one embodiment, determining the current proficiency level of the learner upon identification of the multiple performance parameters may include identification of the multiple performance parameters which may include, but not limited to, at least one of grades secured by the learner, details of a selection of one or more subjects by the learner for assessment, number of questions attempted by the learner, time taken by the learner to attempt each question, time taken by the learner to complete an assessment or a combination thereof.

The method 300 also includes determining a difference between the current proficiency level and a first predetermined threshold limit of the proficiency level corresponding to a current grade level standard used in a predefined geographic location in step 330. In one embodiment, determining the difference between the current proficiency level and the first predetermined threshold limit corresponding to the current grade level standard used in the predefined geographic location may include determining the difference between the current proficiency level and the first predetermined threshold limit used corresponding to the current grade level standard used in a location of a city, state, country and the like.

The method 300 also includes recommending a set of remedial practices to the learner in an event that the current proficiency level is below the first predetermined threshold limit in step 340. In one embodiment, recommending the set of remedial practices to the learner in the event that the current proficiency level is below the first predetermined threshold limit may include recommending the set of remedial practices which may include, but not limited to, at least one of one or more practice questions, one or more assignments of one or more subjects, one or more video lectures, one or more guidance tips or a combination thereof.

The method 300 also includes conducting a practice test based on an evaluation of performance of the set of remedial practices recommended to the learner in step 350. In one embodiment, conducting the practice test based on the evaluation of the performance of the set of practices may include conducting the practice test to check an improvement level in the performance of the learner upon practicing the set of remedial practices. The method 300 also includes determining the difference in the current proficiency level of the learner and a second predetermined threshold limit of the proficiency level corresponding to the current grade level standard based on the practice test attempted by the learner in step 360.

The method 300 also includes identifying a learning requirement of the learner recurrently using a coherence map when the current proficiency level of the learner is below the second predetermined threshold limit of the proficiency level in step 370. The method 300 also includes recommending a set of deep remedial practices to the learner recurrently based on identification of the learning requirement in step 380. In one embodiment, recommending the set of deep remedial practices may include recommending at least one of one or more preliminary knowledge level questions, one or more comprehensive skills, one or more retests, one or more references for tutorials corresponding to a lower grade level standard relative to the current grade level standard or a combination thereof.

In a specific embodiment, the method 300 also includes identifying an advanced knowledge requirement recurrently using a coherence map when the current proficiency level of the learner is above the second predetermined threshold limit. In such embodiment, the method 300 includes imparting a subsequent set of practices corresponding to a higher-grade level standard relative to the current grade level standard when the current proficiency level of the learner is above the second predetermined threshold limit. In such embodiment, the subsequent set of practices may include at least one of one or more higher-order aptitude questions, multiple advanced concepts, multiple advanced sub-concepts or a combination thereof.

In a particular embodiment, the method 300 further includes receiving, by an interactive digital assistant, an input query associated with the learning process from a learner in one or more formats. The method 300 also includes understanding the input query to commence a personalized conversation for each of the learner based on at least one of the current proficiency level of the learner, an achievement of the learner corresponding to the current grade level standard, a type of past interaction of each of the learner, feedback of an educator or a combination thereof. The method 300 also includes analyzing each response obtained from each of the learners to provide a corresponding personalized recommendation for one or more subjects upon commencing the personalized conversation. The method 300 also includes providing higher visibility or priority to important messages which are assigned by the educator for each of the learners. The method 300 also includes providing a set of guided practices like a tutor to each of the learners in accessing one or more education resources of the learning process based on an analysis of each response and the personalized recommendation.

Various embodiments of the present disclosure relate to a system for proficiency assessment of the learner which immediately identifies the learner's area of strength and weaknesses and identifies differences in the current proficiency level for providing personalized recommendation to the learner.

Moreover, the present disclosed system ensures quick access to the right resources with the addition of the interactive digital assistant to aid the learner as well as the educator which further saves time and effort and reduces the chances of one or more errors.

Furthermore, the present disclosed system also identifies the learning requirement of the learner recurrently using the coherence map and enables the educator to recommend the set of deep remedial practices to the learner based on the learning requirement so that the learner may master a skill by referring to a previous foundational learning standard.

It will be understood by those skilled in the art that the forgoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for proficiency assessment and remedial practice comprising:
a performance information receiving subsystem configured to receive performance information of a learner from at least one source;
a learner assessment subsystem operatively coupled to the performance information receiving subsystem, wherein the learner assessment subsystem is configured to determine a current proficiency level of the learner upon identification of a plurality of performance parameters from the performance information received by the performance information receiving subsystem;
a performance comparison subsystem operatively coupled to the learner assessment subsystem, wherein the performance comparison subsystem is configured to determine a difference between the current proficiency level and a first predetermined threshold limit of the proficiency level corresponding to a current grade level standard in a predefined geographic location;
a remedial subsystem operatively coupled to the performance comparison subsystem, wherein the remedial subsystem is configured to recommend a set of remedial practices to the learner in an event that the current proficiency level is below the first predetermined threshold limit; and
a deep remedial subsystem operatively coupled to the remedial subsystem, wherein the deep remedial subsystem comprises:
a test administration module operatively coupled to the remedial subsystem, wherein the test administration module is configured to conduct a practice test based on an evaluation of performance of the set of remedial practices recommended to the learner; and
a proficiency assessment module operatively coupled to the test administration module, wherein the proficiency analysis module is configured to;
determine the difference in the current proficiency level of the learner and a second predetermined threshold limit of the proficiency level corresponding to the current grade level standard based on the practice test attempted by the learner;
identify a learning requirement of the learner recurrently using a coherence map when the current proficiency level of the learner is below the second predetermined threshold limit of the proficiency level; and
recommend a set of deep remedial practices to the learner recurrently based on identification of the learning requirement.

2. The system of claim 1, wherein the at least one source comprises an assessment, an assessment report card or a combination thereof.

3. The system of claim 2, wherein the performance information receiving subsystem is configured to receive the performance information of the learner through scanning of the assessment report card of the learner.

4. The system of claim 2, wherein the performance information receiving subsystem is configured to receive the performance information of the learner through scanning of a unique code from a printed book for taking the assessment or using an access code of an online account.

5. The system of claim 1, wherein the plurality of performance parameters comprises at least one of grades secured by the learner, details of selection of one or more subjects by the learner for the assessment, number of questions attempted by the learner, time taken by the learner to attempt each questions, time taken by the learner to complete the assessment or a combination thereof.

6. The system of claim 1, wherein the set of remedial practices comprises at least one of one or more practice questions, one or more assignments of one or more subjects, one or more video lectures, one or more guidance tips or a combination thereof.

7. The system of claim 1, wherein the remedial subsystem is configured to recommend directly an advanced set of practices corresponding to a higher-grade level standard when the current proficiency level of the learner is above the first predetermined-threshold limit.

8. The system of claim 1, wherein the coherence map comprises a visual representation of a relationship between grade level standards.

9. The system of claim 8, wherein the visual representation comprises at least one of a chart, a graph, a matrix, a table, a diagram or a combination thereof.

10. The system of claim 1, wherein the set of deep remedial practices comprises at least one of one or more preliminary knowledge level questions, one or more comprehensive skills, one or more retests, one or more references for one or more learning resources corresponding to a lower grade level standard or a combination thereof.

11. The system of claim 1, wherein the proficiency assessment module is configured to impart a subsequent set of practices corresponding to a higher-grade level standard recurrently when the current proficiency level of the learner is above the second predetermined threshold limit.

12. The system of claim 1, further comprising an interactive digital assistant configured to provide a set of guided practices to the learner in accessing one or more educational resources, recommending the set of remedial practices, recommending the set of deep remedial practices or a combination thereof.

13. A method comprising:
receiving, by a performance information receiving subsystem, performance information of a learner from at least one source;
determining, by a learner assessment subsystem, a current proficiency level of the learner upon identification of a plurality of performance parameters from the performance information received by the performance information receiving subsystem;
determining, by a performance comparison subsystem, a difference between the current proficiency level and a first predetermined threshold limit of the proficiency level corresponding to a current grade level standard used in a predefined geographic location;
recommending, by a remedial subsystem, a set of remedial practices to the learner in an event that the current proficiency level is below the first predetermined threshold limit;
conducting, by a test administration module of a deep remedial subsystem, a practice test based on an evaluation of performance of the set of remedial practices recommended to the learner;
determining, by a proficiency assessment module of the deep remedial subsystem, the difference in the current proficiency level of the learner and a second predetermined threshold limit of the proficiency level corresponding to the current grade level standard based on the practice test attempted by the learner;
identifying, by the proficiency assessment module, a learning requirement of the learner recurrently using a coherence map when the current proficiency level of the learner is below the second predetermined threshold limit of the proficiency level; and
recommending, by the proficiency assessment module, a set of deep remedial practices to the learner recurrently based on identification of the learning requirement.

14. A system for proficiency assessment and remedial practice with an interactive digital assistant comprising:
a performance information receiving subsystem configured to receive performance information of a learner from at least one source;
a learner assessment subsystem operatively coupled to the performance information receiving subsystem, wherein the learner assessment subsystem is configured to determine a current proficiency level of the learner upon identification of a plurality of performance parameters from the performance information received by the performance information receiving subsystem;
a performance comparison subsystem operatively coupled to the learner assessment subsystem, wherein the performance comparison subsystem is configured to determine a difference between the current proficiency level and a first predetermined threshold limit of the proficiency level corresponding to a current grade level standard used in a predefined geographic location; and
a remedial subsystem operatively coupled to the performance comparison subsystem, wherein the remedial subsystem is configured to recommend a set of remedial practices to the learner in an event that the current proficiency level is below the first predetermined threshold limit;
a deep remedial subsystem operatively coupled to the remedial subsystem, wherein the deep remedial subsystem comprises:
a test administration module operatively coupled to the remedial subsystem, wherein the test administration module is configured to conduct a practice test based on an evaluation of performance of the set of remedial practices recommended to the learner;
a proficiency assessment module operatively coupled to the test administration module, wherein the proficiency assessment module is configured to;
determine the difference in the current proficiency level of the learner and a second predetermined threshold limit of the proficiency level corresponding to the current grade level standard based on the practice test attempted by the learner;
identify a learning requirement of the learner recurrently using a coherence map when the current proficiency level of the learner is below the second predetermined threshold limit of the proficiency level; and
recommend a set of deep remedial practices to the learner recurrently based on identification of the learning requirement; and
an interactive digital assistant operatively coupled to the performance information receiving subsystem, the learner assessment subsystem, the performance comparison subsystem, the remedial subsystem and the deep remedial subsystem, wherein the interactive digital assistant is configured to:
receive an input query associated with a learning process from the learner in one or more formats;
interpret the input query to commence a personalized conversation for each of the learner based on at least one of the current proficiency level of the learner, an achievement of the learner corresponding to the current grade level standard, a type of past interaction of each of the learner, feedback of an educator or a combination thereof;
analyze each response obtained from each of the learners to provide a corresponding personalized recommendation upon commencement of the personalized conversation; and
provide a set of guided practices to the learner in accessing one or more education resources based on an analysis of each response and the personalized recommendation.

15. The system of claim 14, wherein the one or more formats comprises at least one of a text format, a voice format, an image format or a combination thereof.
